(19) United States
(12) Patent Application Publication
(10) Pub. No.: US 2014/0181942 A1
(43) Pub. Date: Jun. 26, 2014

(54) STARTUP METHOD AND APPARATUS, STARTUP-ACCEPTANCE METHOD AND APPARATUS, AND MUTUAL-STARTUP METHOD AND SYSTEM

(71) Applicant: TENCENT TECHNOLOGY (SHENZHEN) COMPANY LIMITED, Shenzhen City (CN)

(72) Inventors: LEI ZHOU, Shenzhen City (CN); HONGYU GUO, Shenzhen City (CN); BIN YU, Shenzhen City (CN); XIANZHI LI, Shenzhen City (CN); XIAOJING TU, Shenzhen City (CN); HAO ZHANG, Shenzhen City (CN); MING MA, Shenzhen City (CN)

(73) Assignee: TENCENT TECHNOLOGY (SHENZHEN) COMPANY LIMITED, Shenzhen City (CN)

(21) Appl. No.: 14/190,045

(22) Filed: Feb. 25, 2014

Related U.S. Application Data
(63) Continuation of application No. PCT/CN2012/079205, filed on Jul. 26, 2012.

(30) Foreign Application Priority Data
Aug. 26, 2011 (CN) 201110249052.9

(51) Int. Cl. G06F 21/31

(52) U.S. Cl. CPC G06F 21/31
USPC 726/7

(57) ABSTRACT

The present invention provides startup method and apparatus, startup-acceptance method and apparatus, and mutual-startup method and system. The startup method includes steps of: receiving an instruction of a user terminal to start up a second application; obtaining a login-status information of the user terminal in a first application; generating a first startup command for starting up the second application; and starting up the second application through the first startup command, delivering the login-status information of the user terminal in the first application to the second application and thereby automatically logging the user terminal into the second application.

### CROSS-REFERENCE TO RELATED APPLICATION

This application is a continuation application of International (PCT) Patent Application No. PCT/CN2012/079205 filed on Jul. 26, 2012, now pending and designating the United States, which also claims benefit of China Patent Application No. 201110249052.9, filed on Aug. 26, 2011. The entirety of the above-mentioned patent applications is hereby incorporated by reference herein and made a part of this specification.

### FIELD OF THE INVENTION

The present invention relates to the field of startup technique, and more particularly to startup method and apparatus, startup-acceptance method and apparatus, and mutual-startup method and system.

### BACKGROUND OF THE INVENTION

With the increasing number of on-line networking software products, the number of a variety of applications running at user terminal, such as office applications, Internet chat applications, games, applications, etc., correspondingly increases. When an application is started up at a user terminal and another application is to be started up, the startup procedure of the to-be-started-up application needs to begin from the very beginning at the user terminal. In other words, if the startup of the to-be-started-up application requires a user to enter login formation, such as the authentication information, so as to log into the to-be-started-up application, the associated system may have relatively heavy load.

### SUMMARY OF THE INVENTION

An objective of the present invention is to provide startup method and apparatus, startup-acceptance method and apparatus, and mutual-startup method and system. In the present invention, the first application can be automatically started up by the second application if the second application is already started up at a user terminal. Thus, the present invention has simpler startup procedure.

The present invention provides a startup method, which includes steps of: receiving an instruction of a user terminal to start up a second application; obtaining a login-status information of the user terminal in a first application; generating a first startup command for starting up the second application; and starting up the second application through the first startup command, delivering the login-status information of the user terminal in the first application to the second application and thereby automatically logging the user terminal into the second application.

The present invention further provides a startup-acceptance method, which includes steps of: receiving a startup command for starting up a second application; parsing a startup parameter in the startup command; determining whether the start parameter carries a login-status information of the user terminal in a first application or not; and starting up the second application and logging the user terminal into the second application according to the login-status information if the login-status information of the user terminal in the first application exists in the start parameter.

The present invention further provides a mutual-startup method used when a first application is already started up by a user terminal and a second application is to be started up through the first application. The method includes steps of: receiving an instruction of the user terminal to start up the second application; obtaining a login-status information of the user terminal in the first application; generating a startup command for starting up the second application; receiving the generated startup command for starting up the second application; parsing a startup parameter in the startup command; determining whether the start parameter carries a login-status information of the user terminal in the first application or not; and starting up the second application and logging the user terminal into the second application according to the login-status information if the login-status information of the user terminal in the first application does not exist in the start parameter.

The present invention further provides a startup apparatus, which includes a startup-initiation module, a startup command generation module and a login module. The startup-initiation module is configured to receive an instruction of a user terminal starting up a second application. The startup command generation module is configured to obtain a login-status information of the user terminal in a first application and accordingly generate a first startup command for starting up the second application. The login module is configured to start up the second application through the first startup command, deliver the login-status information of the user terminal in the first application to the second application and thereby automatically logging the user terminal into the second application.

The present invention further provides a startup-acceptance apparatus, which includes a parsing module and a determination module. The parsing module is configured to receive a startup command for starting up a second application and parse a startup parameter in the startup command. The determination module is configured to determine whether the start parameter carries a login-status information of a user terminal in a first application or not, and start up the second application and log the user terminal into the second application according to the login-status information if the login-status information of the user terminal in the first application exists in the start parameter.

The present invention further provides a mutual-startup system, which includes a startup apparatus and a start-acceptance module. The startup apparatus includes a startup-initiation module, a startup command generation module and a login module. The startup-initiation module is configured to receive an instruction of a user terminal starting up a second application. The startup command generation module is configured to obtain a login-status information of the user terminal in a first application and accordingly generate a first startup command for starting up the second application. The login module is configured to start up the second application through the first startup command, deliver the login-status information of the user terminal in the first application to the second application and thereby automatically logging the user terminal into the second application. The startup-acceptance apparatus includes a parsing module and a determination module. The parsing module is configured to receive a startup command for starting up a second application and parse a startup parameter in the startup command. The determination module is configured to determine whether the start parameter carries a login-status information of a user terminal in a first application or not, and start up the second application and log the user terminal into the second application according to the login-status information if the login-status information of the user terminal in the first application exists in the start parameter.

By generating a startup command from the first application (e.g., host program) already started by at a user terminal, the second application (e.g., client program) can be automatically started up by the startup command. Thus, the startup method and apparatus, startup-acceptance method and apparatus, and mutual-startup method and system of the present invention each have simpler startup procedure.

### BRIEF DESCRIPTION OF THE DRAWINGS

In order to describe the embodiments of the present invention more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts:

FIG. 1 is a flowchart schematically illustrating a mutual-startup method in accordance with an embodiment of the present invention;

FIG. 2A is a flowchart schematically illustrating a startup method in accordance with an embodiment of the present invention;

FIG. 2B is a flowchart schematically illustrating a startup method in accordance with another embodiment of the present invention;

FIG. 3A is a flowchart schematically illustrating a startup-acceptance method in accordance with an embodiment of the present invention;

FIG. 3B is a flowchart schematically illustrating a startup-acceptance method in accordance with another embodiment of the present invention;

FIG. 4 is a schematic diagram of a mutual-startup system in accordance with an embodiment of the present invention;

FIG. 5 is a schematic diagram of a startup apparatus in accordance with an embodiment of the present invention; and

FIG. 6 is a schematic diagram of a startup-acceptance apparatus in accordance with an embodiment of the present invention.

### DETAILED DESCRIPTION OF PREFERRED EMBODIMENTS

Hereinafter, combined with the accompanying drawings of the embodiments of the present invention, the technical solutions of the embodiments of the present invention are clearly and fully described. It is apparent that the embodiments are only some of the embodiments of the present invention other than all the embodiments. Based on the embodiments of the present invention, all the other embodiments derived therefrom without additional inventive efforts of an ordinarily skilled person in the art are included in the scope of the present invention.

### First Embodiment

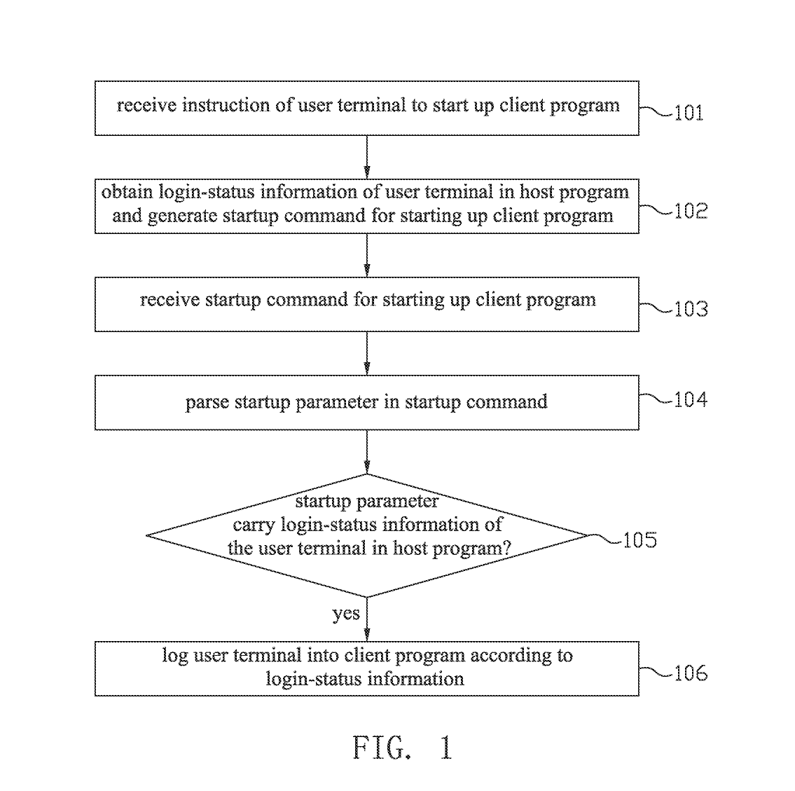

FIG. 1 is a flowchart schematically illustrating a mutual-startup method used with a first application (e.g., a host program) and a second application (e.g., a client program) in accordance with an embodiment of the present invention; wherein the first application (host program) is already started up by a user terminal and the second application (client program) is to be started up through the first application (host program). As shown in FIG. 1, the method in this embodiment includes Steps 101˜106.

Step 101: receive an instruction of the user terminal to start up the second application (client program).

Step 102: obtain login-status information of the user terminal in the first application (host program) and accordingly generate a startup command for starting up the second application (client program).

In one embodiment, the user terminal may refer to as a smart phone, desktop, laptop, etc. The first application (host program) and the second application (client program) each may refer to any application at the user terminal, such as an instant messaging application (e.g., MSN or QQ), social networking platform (e.g., Facebook), browser, game, or financial application.

Step 103: receive, from the first application (host program), the startup command for starting up the second application (client program).

Step 104: parse a startup parameter (e.g., OpenID (identification) of the first application (host program) and the OpenID of the second application (client program)) in the startup command.

Step 105: determine whether determine whether the start parameter carries the login-status information of the user terminal in the first application (host program) or not, and execute step 106 if yes.

Step 106: start up the second application (client program) through the startup command, deliver the login-status information of the user terminal in the first application (host program) to the second application (client program), and automatically log the user terminal into the second application (client program) according to the login-status information.

Another four specific embodiments will be described in detail in the following. The second and third embodiments are used for illustrating a method for the first application (host program) to initiate a startup of the second application (client program); and the fourth and fifth embodiments are used for illustrating a method for the second application (client program) to accept a startup from the first application (host program).

### Second Embodiment

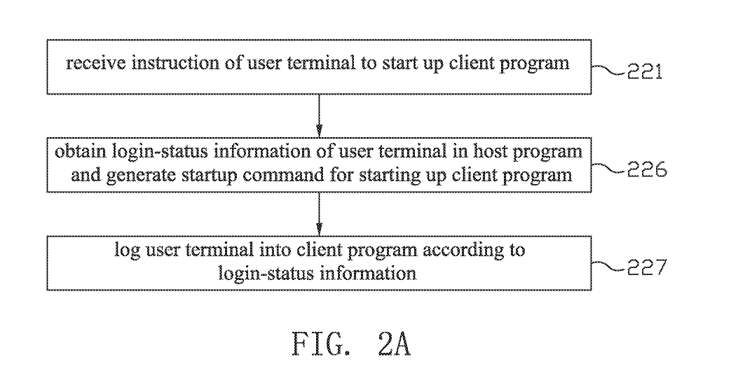

FIG. 2A is a flowchart schematically illustrating a startup method used with a first application (e.g., a host program) and a second application (e.g., a client program) in accordance with an embodiment of the present invention. As shown in FIG. 2A, the method in this embodiment includes steps 221˜227.

Step 221: receive an instruction of a user terminal to start up the second application (client program).

In one embodiment, the instruction for starting up the second application (client program) is issued to the first application (host program) when the instruction is generated by a user clicking on a corresponding link in the first application (host program). In another embodiment, the first application (host program) may automatically start up the second application (client program); for example, anti-virus applications may automatically start up a virus update to obtain the latest virus in the virus update database.

Step 226: obtain the login-status information of the user terminal in the first application (host program) and accordingly generate the startup command for starting up the second application (client program).

In one embodiment, the login-status information may include authentication information, which may be an ID number, password, pupil information, fingerprint information of the user terminal. The startup command may include the OpenID (identification) of the first application (host program), the OpenID of the second application (client program), and the authentication information of the user terminal structured in format of Uniform/Universal Resource Locator (URL). The following is an exemplary first startup command in URL format:

<Client OpenID>:/ /? Host=<Host OpenID> & paramA=<XXXX>

&...

wherein <Client OpenID> stands for the OpenID of the second

application (client program);

<Host OpenID> stands for the OpenID of the first

application (host program);

paramA stands for the first parameter which may carry the

authentication information of the user terminal, such as a user terminal ID
number;

“ . . . ” stands for other parameters such as parameters paramB, paramC, which may carry other login-status information or other authentication information of the user terminal, such as password, pupil information, or fingerprint information.

Step 227: start up the second application (client program) through the startup command, deliver the login-status information of the user terminal in the first application (host program) to the second application (client program) and thereby automatically logging the user terminal into the second application (client program).

In one embodiment, the automatic login of the user terminal to the second application (client program) may be realized by adopting the login-status information of the user terminal as the authentication information thereof.

### Third Embodiment

FIG. 2B is a flowchart schematically illustrating a startup method used with a first application (e.g., a host program) and a second application (e.g., a client program) in accordance with another embodiment of the present invention. As shown in FIG. 2B, the method in this embodiment includes steps 201˜210.

Step 201: receive an instruction of a user terminal to start up the second application (client program).

In one embodiment, the instruction for starting up the second application (client program) is issued to the first application (host program) when the instruction is generated by a user clicking on a corresponding link in the first application (host program). In another embodiment, the first application (host program) may automatically start up the second application (client program); for example, anti-virus applications may automatically start up a virus update to obtain the latest virus in the virus update database.

Step 202: obtain OpenID of the first application (host program) and OpenID of the second application (client program).

Step 203: determine whether the second application (client program) is installed or not, wherein the determination may be realized via the OpenID of the second application (client program); and execute step 204 if yes or execute step 205 if not.

Step 205: direct the user terminal to an application download page for downloading and installing the second application (client program) and then execute step 204.

In one embodiment, the application download page may be a WAP page.

Step 204: determine whether the user terminal is in a login status in the first application (host program); and execute step 206 if yes or execute step 209 if not.

In one embodiment, the determination of whether the user terminal is in a login status in the first application (host program) may be realized via the OpenID of the first application (host program).

Step 206: obtain the login-status information of the user terminal in the first application (host program) and accordingly generate a first startup command for starting up the second application (client program).

In one embodiment, the login-status information may include authentication information, which may be an ID number, password, pupil information, fingerprint information of the user terminal. The first startup command may include the OpenID (identification) of the first application (host program), the OpenID of the second application (client program), and the authentication information of the user terminal structured in format of Uniform/Universal Resource Locator (URL). The following is an exemplary first startup command in URL format:

<Client OpenID>:/ /? Host=<Host OpenID> & paramA=<XXXX>

&...

wherein <Client OpenID> stands for the OpenID of the second

application (client program);

<Host OpenID> stands for the OpenID of the first application (host

program);

paramA stands for the first parameter which may carry the

authentication information of the user terminal, such as a user terminal ID
number;

“ . . . ” stands for other parameters such as parameters paramB, paramC, which may carry other login-status information or other authentication information of the user terminal, such as password, pupil information, or fingerprint information.

In one embodiment, the second application (client program) may obtain parameters by parsing the URL command so as to start up the automatic login process.

Step 207: start up the second application (client program) through the first startup command (URL format), deliver the login-status information of the user terminal in the first application (host program) to the second application (client program) and thereby automatically logging the user terminal into the second application (client program).

In one embodiment, the automatic login of the user terminal to the second application (client program) may be realized by adopting the login-status information of the user terminal as the authentication information thereof.

Step 209: automatically generate a second startup command for starting up the second application (client program).

In one embodiment, the second startup command may include the OpenID (identification) of the first application (host program) and the OpenID of the second application (client program) structured in format of Uniform/Universal Resource Locator (URL). It is to be noted that the second startup command (URL format) generated in this step is similar to the first startup command generated in step 206, except that the second startup command (URL format) generated in this step does not contain the login-status information of the user terminal, such as authentication information.

Step 210: call, through the second startup command, the second application (client program) and complete the startup of the second application (client program) according to a respective startup procedure.

In one embodiment, the startup of the second application (client program) is based on the respective specific startup procedure. Basically, for the startup of the second application (client program), the user terminal may be required to enter the authentication information thereof first and then process specific following processes. For example, if the second application (client program) is a game application, the user terminal may need to enter the authentication information, such as the account number or passwords, into a specific box of the second application (client program) first, and then process specific following startup processes of the second application (client program), such as application initialization or loading startup information.

The following is an exemplary IOS platform code for illustrating the embodiment of the present invention; herein the first application (host program) is exemplified by QQDDZ application and the second application (client program) is exemplified by QQZONE application:

NSString * url
= [NSString stringWithFormat: @ “% @ ://? Host =% @ & uin =% d &
pwd =% s”,

QQDDZ_OPEN_ID,
QQZONE_OPEN_ID,
user_qq_number,

user_qq_password];
// The codes indicates that the program with identification
QQZONE_OPEN_ID is started up by the program with identification
QQDDZ_OPEN_ID, and simultaneously authentication information of
the user terminal in the program QQDDZ_OPEN_ID (e.g.,
user_qq_number (user's QQ number) and user_qq_password (ser's QQ
password)) is delivered
if ([[UIApplication sharedApplication] canOpenURL: [NSURL
URLWithString: url]]) // If the startup is successful
{
// Perform the corresponding procedure after a successful startup
}
else / / If the startup is unsuccessful
{
/ / Direct to APP STORE for downloading proframs
}

### Fourth Embodiment

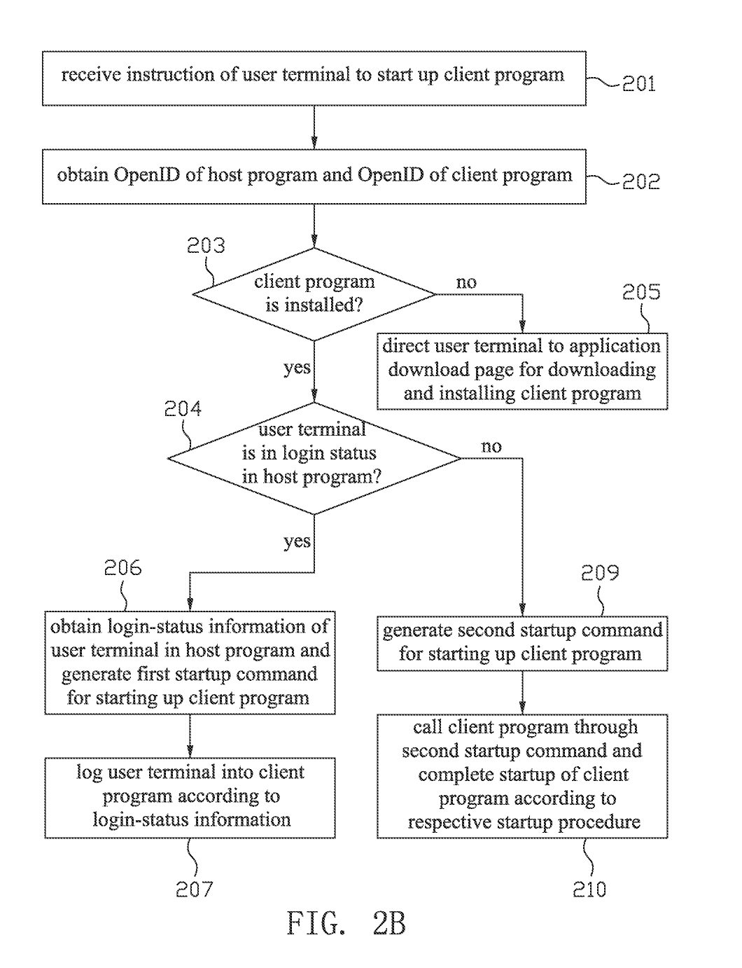

FIG. 3A is a flowchart schematically illustrating a startup-acceptance method used with a first application (e.g., a host program) and a second application (e.g., a client program) in accordance with an embodiment of the present invention. As shown, the method in this embodiment includes steps 331˜337.

Step 331: receive a startup command for starting up the second application (client program) issued from the first application (host program).

Step 332, parse a startup parameter in the startup command, wherein the startup parameter may include OpenID (identification) of the first application (host program) and OpenID of the second application (client program).

In one embodiment, the startup command may have an URL format.

Step 335: determine whether the start parameter carries login-status information of a user terminal in the first application (host program) or not, and execute step 337 if yes.

Step 337: start up the second application (client program) and automatically log the user terminal into the second application (client program) according to the login-status information.

Thus, without entering some specific information such as the authentication information, a user can automatically log into the second application (client program).

### Fifth Embodiment

FIG. 3B is a flowchart schematically illustrating a startup-acceptance method used with a first application (e.g., a host program) and a second application (e.g., a client program) in accordance with another embodiment of the present invention. As shown, the method in this embodiment includes steps 301310.

Step 301: receive, by the second application (client program), a startup command for starting up the second application (client program) issued from the first application (host program).

Step 302: parse, by the second application (client program), a startup parameter in the startup command, wherein the startup parameter may include the OpenID (identification) of the first application (host program) and the OpenID of the second application (client program).

In one embodiment, the startup command may have an URL format.

Step 303: determine, by the second application (client program), whether the first application (host program) is valid or not, and execute step 305 if yes or execute step 304 if not.

Step 304: inform that the first application (host program) is fail to start up.

Step 355: determine, by the second application (client program), whether the start parameter carries the login-status information of the user terminal or not, and execute step 307 if yes or execute step 306 if not.

In one embodiment, the login-status information is, for example, authentication information.

Step 307: start up the second application (client program) and automatically log the user terminal into the second application (client program) according to the login-status information.

Thus, without entering some specific information such as the authentication information, a user can automatically log into the second application (client program).

Step 306: complete the startup of the second application (client program).

In one embodiment, the startup of the second application (client program) is based on the respective specific startup procedure. Basically, for the startup of the second application (client program), the user terminal may need to be entered with the authentication information first and then the following specific processes are consequentially processed.

Step 309: determine whether receiving a command for returning back to the first application (host program) or not, and execute step 310 if yes or execute step 309 if not.

In one embodiment, the second application (client program) will receive the command for returning back to the first application (host program) if the user selects to exit the second application (client program).

Step 310: exit the second application (client program) and return back to the first application (host program).

### Sixth Embodiment

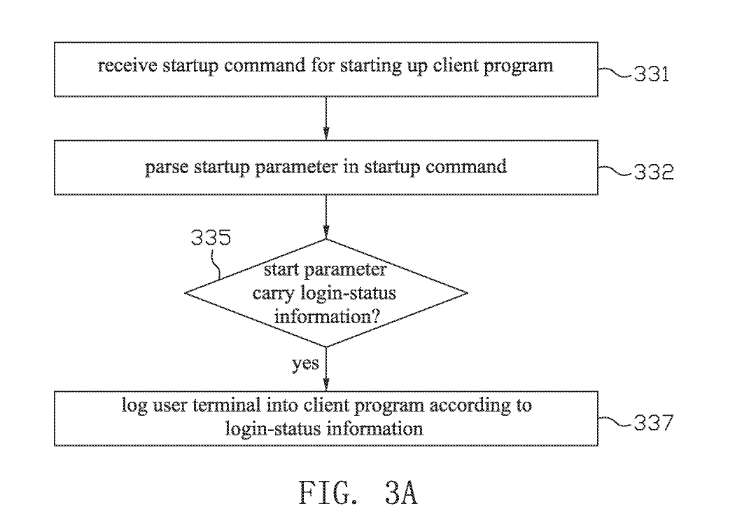

FIG. 4 is a schematic diagram of a mutual-startup system used between a first application (e.g., a host program) and a second application (e.g., a client program) in accordance with an embodiment of the present invention. As shown, the mutual-startup system in this embodiment includes a startup apparatus 41 and a to-be-startup apparatus 43.

The startup apparatus 41 includes a startup-initiation module 401, a startup command generation module 402 and a login module 403. The to-be-startup apparatus 43 includes a parsing module 431 and a determination module 432.

The startup-initiation module 401 is configured to receive an instruction of a user terminal to start up the second application (client program).

The startup command generation module 402 is configured to obtain the login-status information of the user terminal in the first application (host program) and accordingly generate a startup command for starting up the second application (client program).

The parsing module 431 is configured to receive the startup command from the first application (host program) and parse the startup parameters (e.g., the OpenID (identification) of the first application (host program) and the OpenID of the second application (client program), etc.) in the startup command.

The login module 403 is configured to start up the second application (client program) through the startup command and deliver the login-status information of the user terminal in the first application (host program) to the second application (client program).

The determination module 432 is configured to determine whether there exists the login-status information, of the user terminal in the first application (host program), in the startup parameters or not, and start up the second application (client program) and automatically log the user terminal into the second application (client program) according to the login-status information if yes.

### Seventh Embodiment

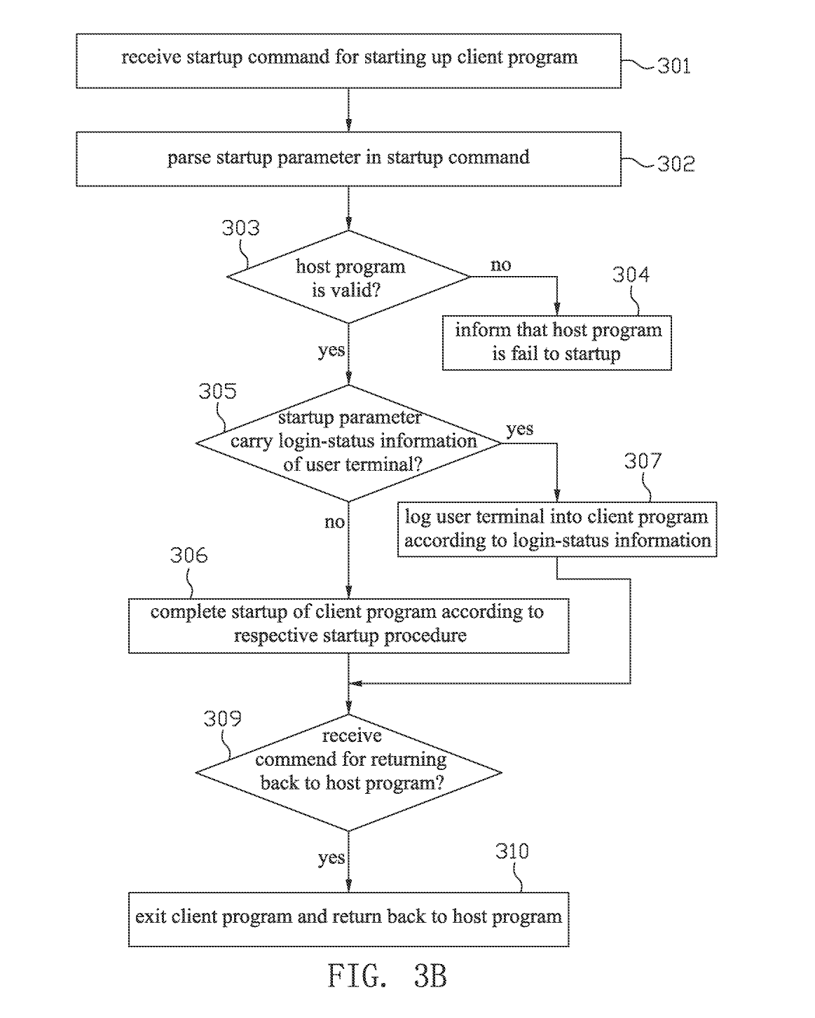

FIG. 5 is a schematic diagram of a startup apparatus used with a first application (e.g., a host program) and a second application (e.g., a client program) in accordance with an embodiment of the present invention. As shown, the startup apparatus in this embodiment includes a startup-initiation module 501, a startup command generation module 502 and a login module 503.

The startup-initiation module 501 is configured to receive an instruction of a user terminal to start up the second application (client program).

In one embodiment, the instruction for starting up the second application (client program) is issued to the startup-initiation module 501 when the instruction is generated by a user clicking on a corresponding link in the first application (host program). In another embodiment, the first application (host program) may automatically start up the second application (client program); for example, anti-virus applications may automatically start up a virus update to obtain the latest virus in the virus update database.

In one embodiment, the startup-initiation module 501 may be further configured to obtain the OpenID (identification) of the first application (host program) and the OpenID of the second application (client program).

The startup command generation module 502 is configured to obtain login-status information of a user terminal in the first application (host program) and accordingly generate a first startup command for starting up the second application (client program).

In one embodiment, the login-status information may include authentication information, which may be an ID number, password, pupil information, fingerprint information of the user terminal. The first startup command may include the OpenID of the first application (host program), the OpenID of the second application (client program), and the authentication information of the user terminal structured in format of Uniform/Universal Resource Locator (URL).

The login module 503 is configured to start up the second application (client program) through the first startup command, deliver the login-status information of the user terminal in the first application (host program) to the second application (client program) and thereby automatically logging the user terminal into the second application (client program).

In one embodiment, the automatic login of the user terminal to the second application (client program) may be realized by adopting the login-status information of the user terminal as the authentication information thereof.

In addition, the startup apparatus in one embodiment may further include a determination module 505.

The determination module 505 is configured to determine whether the second application (client program) is installed or not; specifically, the second application (client program) is to be downloaded and installed if not.

In one embodiment, the determination module 505 is further configured to determine whether the user terminal is in a login status in the first application (host program). Specifically, the startup command generation module 502 obtains the login-status information of the user terminal in the first application (host program) and generates the first startup command including the login-status information, if yes; alternatively, the startup command generation module 502 generates a second startup command, if not, and correspondingly the second application (client program) is started up through the second startup command (URL format).

The second startup command may include the OpenID of the first application (host program) and the OpenID of the second application (client program) structured in format of Uniform/Universal Resource Locator (URL). It is to be noted that the second startup command herein does not include the login-status information of the user terminal such as the authentication information. In addition, the startup of the second application (client program) is based on the respective specific startup procedure. Basically, for the startup of the second application (client program), the user terminal may need to be entered with the authentication information first and then the following specific processes are consequentially processed.

### Eighth Embodiment

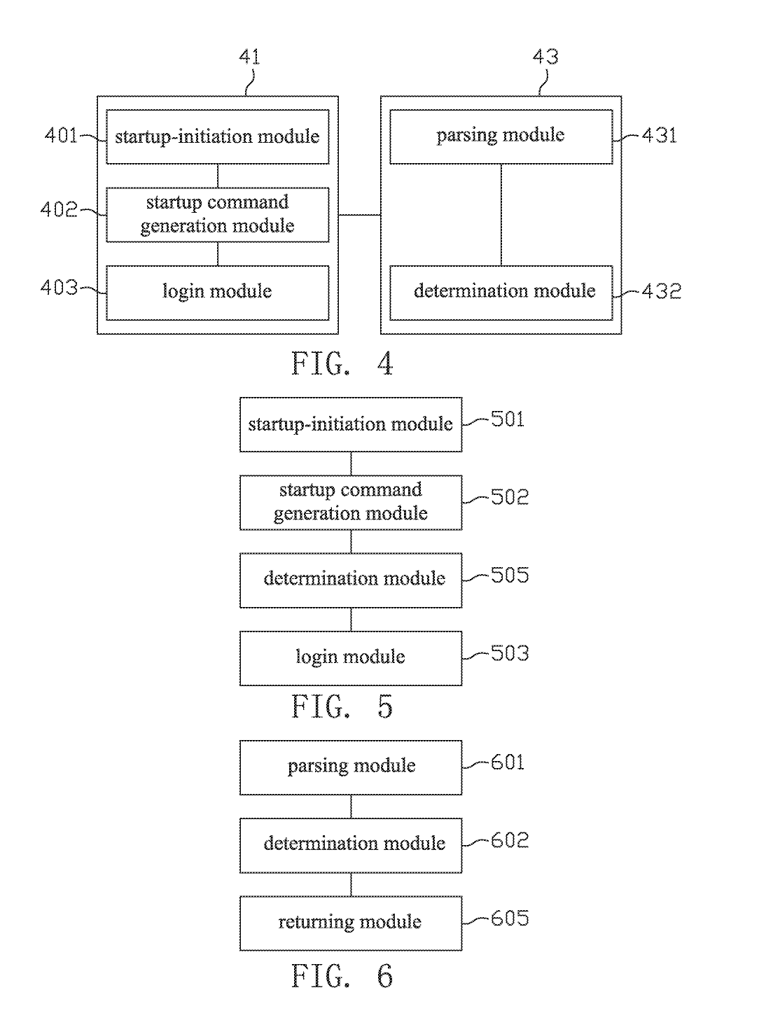

FIG. 6 is a schematic diagram of a startup-acceptance apparatus used with a first application (e.g., a host program) and a second application (e.g., a client program) in accordance with an embodiment of the present invention. As shown, the startup-acceptance apparatus in this embodiment includes a parsing module 601 and a determination module 602.

The parsing module 601 is configured to receive a startup command for starting up the second application (client program) issued from the first application (host program) and parse a startup parameter in the startup command; wherein the startup parameter may include the OpenID of the first application (host program) and the OpenID of the second application (client program).

In one embodiment, the startup command may have an URL format.

The determination module 602 is configured to determine whether the start parameter carries login-status information of a user terminal in the first application (host program) or not, and start up the second application (client program) and automatically log the user terminal into the second application (client program) according to the login-status information if yes.

Thus, without entering some specific information such as the authentication information, a user can automatically log into the second application (client program).

In one embodiment, the determination module 602 may be further configured to determine whether the first application (host program) is valid or not. Consequentially, the determination module 602 determines whether the start parameter carries login-status information of the user terminal or not, if yes; a fail startup of the first application (host program) is informed if the first application (host program) is not valid.

In one embodiment, the determination module 602 may be further configured to complete the startup of the second application (client program) according to a respective startup procedure if the login-status information of the user terminal in the first application does not exist in the start parameter.

The login-status information is, for example, authentication information. Thus, without entering some specific information such as the authentication information, a user can automatically log into the second application (client program). In addition, the startup of the second application (client program) is based on the respective specific startup procedure. Basically, for the startup of the second application (client program), the user terminal may need to be entered with the authentication information first and then the following specific processes are consequentially processed.

In one embodiment, the startup-acceptance apparatus may further include a returning module 605.

The returning module 605 is configured to determine whether receiving a command for returning back to the first application (host program) or not, and exit the second application (client program) and return back to the first application (host program) if the command for returning back to the first application (host program) is received.

The aforementioned embodiments are exemplarily described by URL format; however, it is understood that the startup of the client program by the host program may be realized by other platforms, such as Runloop, Socket or other specific communication mechanisms.

In addition, the present embodiment mat further count the client programs and thereby distinguishing the data flow rates from the respective client programs, obtaining the effects and competitions between each application and the characteristics of the user at the user terminal. For example, by counting the client programs, a game program may be more competitive if the game program has a higher data flow rate than a financial program has. In addition, by counting the data flow rates of the programs, a user may be referred to as a game player or a financial follower. Moreover, by further counting the started-up client programs and analyzing the data obtained therefrom, some new applications capable of drawing user's attention can be developed and introduced to users in time.

In summary, by generating a startup command from the host program already started by at a user terminal, the startup method and apparatus, startup-acceptance method and apparatus, and mutual-startup method and system of the present invention each can start up the client program by the startup command; thus, the startup procedure in the present invention is much simpler. In addition, by delivering the authentication information such as the user ID number or password in the host program to the client program, a user can automatically log into the client program without entering the authentication information again.

Moreover, the ordinary skill in the art can understand that all or part of the processes in the method embodiments can be realized by computer programs controlling related hardware. The computer programs for executing the aforementioned procedure may be stored in a computer storage medium, such as a magnetic disk, optical disk, read-only memory (ROM), or random access memory (RAM), etc.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A startup method, comprising:
receiving an instruction of a user terminal to start up a second application;
obtaining a login-status information of the user terminal in a first application;
generating a first startup command for starting up the second application; and
starting up the second application through the first startup command, delivering the login-status information of the user terminal in the first application to the second application and thereby automatically logging the user terminal into the second application.

2. The method according to claim 1, wherein after the step of receiving an instruction of a user terminal to start up a second application and before the step of obtaining a login-status information of the user terminal in a first application, the method further comprises:
obtaining identifications of the first and second applications;
determining whether the second application is installed or not according to the identification of the second application; and
downloading and installing the second application if the second application is not installed.

3. The method according to claim 1, wherein after the step of receiving an instruction of a user terminal to start up a second application and before the step of obtaining a login-status information of the user terminal in a first application, the method further comprises:
determining whether the user terminal is in a login status in the first application or not;
obtaining the login-status information of the user terminal in the first application if the user terminal is in a login status in the first application; or
generating a second startup command for starting up the second application and starting the second application through the second startup command if the user terminal is not in a login status in the first application.

4. The method according to claim 2, wherein the first startup command has a format of Uniform/Universal Resource Locator (URL) and comprises the login-status information of the user terminal in the first application and the identifications of the first and second applications.

5. A startup-acceptance method, comprising:
receiving a startup command for starting up a second application;
parsing a startup parameter in the startup command;
determining whether the start parameter carries a login-status information of the user terminal in a first application or not; and
starting up the second application and logging the user terminal into the second application according to the login-status information if the login-status information of the user terminal in the first application exists in the start parameter.

6. The method according to claim 5, wherein after the step of parsing a startup parameter in the startup command, the method further comprises:
determining whether the first application is valid or not;
executing the step of determining whether the start parameter carries the login-status information of the user terminal in the first application or not if the first application is valid; or
informing that the first application is fail to start up if the first application is not valid.

7. The method according to claim 5, wherein the step of determining whether the start parameter carries a login-status information of the user terminal in a first application or not further comprises:
completing the startup of the second application according to a respective startup procedure if the login-status information of the user terminal in the first application does not exist in the start parameter.

8. The method according to claim 5, wherein after the step of determining whether the start parameter carries a login-status information of the user terminal in a first application or not, the method further comprises:
determining whether receiving a commend for returning back to the first application or not; and
exiting the second application and returning back to the first application if the command for returning back to the first application is received.

9. A mutual-startup method used when a first application is already started up by a user terminal and a second application is to be started up through the first application, the method comprising:
receiving an instruction of the user terminal to start up the second application;
obtaining a login-status information of the user terminal in the first application;
generating a startup command for starting up the second application;
receiving the generated startup command for starting up the second application;
parsing a startup parameter in the startup command;
determining whether the start parameter carries a login-status information of the user terminal in the first application or not; and
starting up the second application and logging the user terminal into the second application according to the login-status information if the login-status information of the user terminal in the first application does not exist in the start parameter.

10. A startup apparatus, comprising:
a startup-initiation module configured to receive an instruction of a user terminal starting up a second application;
a startup command generation module configured to obtain a login-status information of the user terminal in a first application and accordingly generate a first startup command for starting up the second application; and
a login module configured to start up the second application through the first startup command, deliver the login-status information of the user terminal in the first application to the second application and thereby automatically logging the user terminal into the second application.

11. The apparatus according to claim 10, further comprising:
a determination module configured to determine whether the second application is installed or not, wherein the second application is downloaded and installed if the second application is not installed.

12. The apparatus according to claim 11, wherein the determination module is further configured to determining whether the user terminal is in a login status in the first application or not; wherein the startup command generation module obtains the login-status information of the user terminal in the first application if the user terminal is in a login status in the first application, alternatively, the startup command generation module generates a second startup command for calling the second application and thereby completing the startup of the second application according to a respective startup procedure if the login-status information of the user terminal in the first application does not exist in the start parameter.

13. The apparatus according to claim 10, wherein the startup command generation module generates the first startup command in format of Uniform/Universal Resource Locator (URL).

14. A startup-acceptance apparatus, comprising:
a parsing module configured to receive a startup command for starting up a second application and parse a startup parameter in the startup command; and
a determination module configured to determine whether the start parameter carries a login-status information of a user terminal in a first application or not, and start up the second application and log the user terminal into the second application according to the login-status information if the login-status information of the user terminal in the first application exists in the start parameter.

15. The apparatus according to claim 14, wherein the determination module is further configured to determine whether the first application is valid or not, wherein the second application is executed if the first application is valid, alternatively, a startup fail of the first application is informed if the first application is not valid.

16. The apparatus according to claim 14, wherein the determination module is further configured to complete the startup of the second application according to a respective startup procedure if the login-status information of the user terminal in the first application does not exist in the start parameter.

17. The apparatus according to claim 14, further comprising:
a returning module configured to determine whether receiving a command for returning back to the first application or not, and exit the second application and return back to the first application if the command for returning back to the first application is received.

18. A mutual-startup system, comprising:
a startup apparatus, comprising:
a startup-initiation module configured to receive an instruction of a user terminal starting up a second application;
a startup command generation module configured to obtain a login-status information of the user terminal in a first application and accordingly generate a startup command for starting up the second application; and
a login module configured to start up the second application through the startup command, deliver the login-status information of the user terminal in the first application to the second application and thereby automatically logging the user terminal into the second application; and
a start-acceptance module, comprising:
a parsing module configured to receive the startup command for starting up the second application issued from the startup apparatus and parse a startup parameter in the startup command; and
a determination module configured to determine whether the start parameter carries a login-status information of a user terminal in the first application or not, and start up the second application and log the user terminal into the second application according to the login-status information if the login-status information of the user terminal in the first application exists in the start parameter.
